(19) United States
(12) Patent Application Publication
(10) Pub. No.: US 2006/0251190 A1
(43) Pub. Date: Nov. 9, 2006

(54) Frequency offset estimation for DPSK

(75) Inventors: Tingwu Wang, Singapore (SG); Ju Yan Pan, Singapore (SG); Zhiyong Xiao, Singapore (SG); Yu Jing Ting, Singapore (SG); Yang Yu, Singapore (SG)

Correspondence Address: QUARLES & BRADY LLP, 411 E. WISCONSIN AVENUE, SUITE 2040, MILWAUKEE, WI, 53202-4497, US

(73) Assignee: Oki Techno Centre (Singapore) Pte Ltd

(21) Appl. No.: 11/405,748

(22) Filed: Apr. 18, 2006

(30) Foreign Application Priority Data
May 5, 2005 (SG) 200503022-6

(51) Int. Cl. H04L 27/22

(52) U.S. Cl. 375/330

(57) ABSTRACT

There is provided an apparatus and method for estimating frequency offset for a receiver for DPSK signals comprising in-phase I and quadrature Q components for a plurality of symbols k. The apparatus comprises a differential detector for performing differential detection of a received signal over a symbol span of n symbols, where n is an integer greater than 1, a frequency corrector for performing an initial correction of I and Q using a previously estimated value of the frequency offset, a rotation block for rotating the phase of each symbol towards zero; and a calculator for calculating an estimate of the frequency offset by comparing the phase of each symbol with zero, the calculator being arranged to input the estimate into the frequency corrector for improving the previously estimated value of the frequency offset.

### FIELD OF THE INVENTION

The invention relates to an apparatus and method for frequency offset estimation for DPSK signals. Particularly, but not exclusively, the invention relates to an apparatus and method for frequency offset estimation for

$$\frac{π}{4} DQPSK$$

signals.

### BACKGROUND OF THE INVENTION

Phase Shift Keying (PSK) and Differential Phase Shift Keying (DPSK) modulation schemes are widely used in wireless communication. In DPSK (including variations DQPSK—Differential Quadrature Phase Shift Keying and DBPSK—Differential Bi-Phase Shift Keying), the phase of the carrier is discretely varied in relation to the phase of the immediately preceding signal element and in accordance with the data being transmitted.

One problem with digital communication in general is the residual frequency offset. In summary, when receiving and de-modulating a digitally modulated signal, an estimated replica of the received carrier frequency is used to recover the signal. Ideally, the transmitter generates a carrier signal that exists at some known frequency and the received signals are then demodulated at the receiver using the same known frequency. However, inaccuracies in the transmitter and receiver oscillators, along with the effect of Doppler Shifting, result in carrier frequency offsets. If the frequency offset is excessive and not suitably compensated, the performance of the demodulator will be degraded and the original signal may not be recoverable.

Residual frequency offset is usually compensated for by phase locked loop (where the received carrier phase is continuously tracked for frequency offset compensation) or forward frequency estimation (where the frequency offset is estimated at regular intervals). Frequency estimation can be simplified by using DBPSK, DQPSK or

$$\frac{π}{4} DQPSK ,$$

as only a small phase difference between two adjacent symbols affects the symbol decision. This phase difference corresponds to the frequency offset.

In

$$\frac{π}{4} PSK ,$$

the phase of the carrier can take one of four values

$$( \frac{π}{4} , \frac{3 π}{4} , \frac{- 3 π}{4} and \frac{- π}{4} )$$

and thus two bits can be represented per symbol.

The system described in “Personal Handy Phone System”, ARIB Standard, Version 4.0, February 2003, uses

$$\frac{π}{4} DQPSK$$

modulation to achieve 32 kbps in each slot. In a more advanced version (Advanced Personal Handy Phone System) 16 QAM (16-state Quadrature Amplitude Modulation) and 64 QAM (64-state Quadrature Amplitude. Modulation) are introduced to increase the transmission rate from 32 kbps to 64 kbps and 96 kbps respectively.

QAM essentially involves altering both the phase and the amplitude of the carrier signal so that more bits can be transmitted per baud. The space diagram for 16 QAM is illustrated in FIG. 1 and it can be seen that, since there are 16 (=2⁴) possible states, 4 bits per symbol can be represented. Since

$$\frac{π}{4} DQPSK$$

is only able to represent 2 bits per symbol, using 16 QAM provides a two-fold increase in bit rate i.e. from 32 kbps to 64 kbps. The space diagram for 64 QAM is illustrated in FIG. 2 and it can be seen that, since there are 64 (=2⁶) possible states, 6 bits per symbol can be represented. This provides a three-fold increase in bit rate over

$$\frac{π}{4} DQPSK$$

i.e. from 32 kbps to 96 kbps.

The slot structure for the Advanced Personal Handy Phone System is shown in FIG. 3. The slot comprises the

$$\frac{π}{4} DQPSK$$

preamble, a stream of 16 QAM or 64 QAM symbols and a number of GT (Guard Time) symbols. The guard time is a time interval (of a given number of symbols) where nothing is transmitted, to help combat intersymbol interference.

16 QAM and 64 QAM modulations require an estimation of the frequency offset, and a relatively small error in frequency offset estimation will mean a big phase error over the number of symbols in the slot, as follows:

$$Phaseerror = \frac{{Δ}_{F}}{Symbol Rate} \cdot 360 \cdot {N}_{SYM} \qquad [ 1 ]$$

where the phase error is the fixed phase offset error in the waveform accumulated over N_{SYM} symbols with a frequency offset estimation error of Δ_{F}.

For example, with equation [1], a frequency.offset estimation error, Δ_{F} of 100 Hz and a symbol rate of 192 kHz will mean a phase error of 18.7° after 100 symbols or, putting it another way, a phase error between symbols of 0.1875°. It can be seen clearly from FIGS. 1 and 2 that both 16 QAM and 64 QAM will be sensitive to frequency offset estimation error but that 64 QAM will be more sensitive than 16 QAM. Thus, a fine tuning of frequency estimation is required to achieve acceptable bit error rate (BER) performance for 16 QAM and 64 QAM.

Consider the prior art arrangement shown in FIGS. 4a and 4b. FIG. 4a shows the prior art transmission side and FIG. 4b shows the prior art receiver side. Both FIGS. 4a and 4b relate to

$$\frac{π}{4} DQPSK$$

modulation.

Referring to FIG. 4a, a message 401 is represented by a number of symbols k. Remembering that for

$$\frac{π}{4} DQPSK ,$$

two bits can be transmitted per symbol, it makes sense to define the input binary data as X(k) and Y(k). The binary data is modulated in modulator 403 as:
I(k)=I(k−1)cos {Δ_{Φ}(X(k),Y(k))}−Q(k−1) sin {Δ₁₀₁ (X(k),Y(k))} [2]
Q(k)=Q(k−1)cos {Δ₁₀₁(X(k),Y(k))}+I(k−1)sin {Δ₁₀₁(X(k),Y(k))} [3]
where I(k) is the inphase component at symbol k, Q(k) is the quadrature component at symbol k and Δ₁₀₁(X(k), Y(k)) is the phase difference based on the binary data X(k) and Y(k).

$$When X ( k ) = Y ( k ) = 0 , {Δ}_{Φ} = \frac{π}{4}$$

$$When X ( k ) = Y ( k ) = 1 , {Δ}_{Φ} = \frac{- 3 π}{4}$$

$$When X ( k ) = 0 , Y ( k ) = 1 , {Δ}_{Φ} = \frac{3 π}{4}$$

$$When X ( k ) = Y ( k ) = 0 , {Δ}_{Φ} = \frac{- π}{4}$$

Some sort of frequency offset Δ_{f} is added at operator block 405 giving new I_{f}(k) and Q_{f}(k), as follows:
I_{f}(k)=I(k−1)cos(2πΔ_{f}t+Δₚ)−Q(k−1)sin(2πΔ_{f}t+Δₚ) [4]
Q_{f}(k)=Q(k−1)cos(2πΔ_{f}t+Δₚ)+I(k−1)sin(2πΔ_{f}t+Δₚ) [5]
where Δₚ is the phase offset error.

It can be seen that, when there is zero frequency offset (Δ_{f}=0) and zero phase offset error (Δₚ=0), I_{f}(k) becomes I(k−1) and Q_{f}(k) becomes Q(k−1) i.e. there is no additional phase shift between one symbol and the next.

Additive White Gaussian Noise (AWGN) is added at operator block 407 and the eventually transmitted signal is represented by Iₜ and Qₜ.

FIG. 4b shows a known way to estimate and correct the frequency offset, as described in Proakis, Digital Communications, “Chapter 6: Carrier and symbol synchronization,” McGraw-Hill International Editions, Singapore, 3^{rd} edition, 1995.

The received signal is represented by Iᵣ and Qᵣ and we assume that Iᵣ and Qᵣ are digitized and contain frequency offset (which we are going to estimate) since they have passed through coherent PSK modulation.

Referring to FIG. 4b, block 409 performs differential detection of one symbol span i.e.
I_{d}(k)=Iᵣ(k)Iᵣ(k−1)+Qᵣ(k)Qᵣ(k−1) [6]
Q_{d}(k)=Qᵣ(k)Iᵣ(k−1)−Iᵣ(k)Qᵣ(k−1) [7]

Block 411 performs a frequency correction using a previously estimated value of the frequency offset Δ_{f}′, (using a frequency offset estimation algorithm) to compensate for the differential detection output i.e. this correction is performed on the differential detection output I_{d} and Q_{d} which contain frequency offset error. The correction performed in block 411 is a first stage of correction.
I_{c}(k)=I_{d}(k)cos(2πΔ_{f}′k)+Q_{d}(k)sin(2πΔ_{f}′k) [8]
Q_{c}(k)=Q_{d}(k)cos(2πΔ_{f}′k)−I_{d}(k)sin(2πΔ_{f}′k) [9]

An initial attempt at getting the frequency offset estimation correct may be to set Δ_{f}′=0. This is described in U.S. Pat. No. 5,574,399—Coherent PSK detector not requiring carrier recovery. An improved attempt at getting the frequency offset estimation correct may be to set Δ_{f}′ to a fixed value of approximately the right order. This is described in U.S. Pat. No. 6,038,267—Digital demodulator, maximum-value selector, and diversity receiver.

The pre-correction in block 411 reduces the possibility of the signal erroneously dropping into the neighbour quadrant in the x-y coordinate, which increases estimation accuracy. This is because this step is an attempt to reduce the frequency offset error to within a quadrant

$$( \frac{π}{2} )$$

before we perform finer frequency estimation.

Block 413 performs decision based rotation to produce Iₙ and Qₙ. This is illustrated in FIG. 5. Block 413 uses hard decisions for the I and Q signals to rotate I_{c} and Q_{c} towards the x-axis of the first quadrant. Thus, if the signal is originally in the first quadrant (A), a

$$\frac{π}{4}$$

rotation clockwise will be required. If the signal is originally in the second quadrant (B), a

$$\frac{3 π}{4}$$

rotation clockwise will be required. If the signal is originally in the third quadrant (C), a

$$\frac{5 π}{4}$$

rotation clockwise (equivalent to a

$$\frac{3 π}{4}$$

rotation anti-clockwise as shown in FIG. 5) will be required. If the signal is originally in the fourth quadrant (D), a

$$\frac{7 π}{4}$$

rotation clockwise (equivalent to a

$$\frac{π}{4}$$

rotation anti-clockwise as shown in FIG. 5) will be required. Note that these values are the values on which the

$$\frac{π}{4} DQPSK$$

system of modulation is based. This step is included so that all symbols, irrespective of their quadrant, can be compared with a single value at the next step. This simplifies the comparison.

The term “hard decision” refers to any one of the four (in the case of

$$\frac{π}{4} DQPSK )$$

phases in the constellation after mapping. A received signal can be converted by choosing the one of the four phases in the constellation which is closest to the signal in terms of distance.

In fact, instead of using hard decisions, to rotate the signals, known signals (preambles) can be used, but, in that case, the correct symbol synchronization needs to be obtained first. This means that, instead of comparing the signal to the closest coordinate in the constellation, we compare with the preamble with which the signals are meant to correspond. In PHS, the preambles are transmitted at the beginning of the slot (see FIG. 3) and are modulated by

$$\frac{π}{4} DQPSK .$$

Once we have performed the decision-based rotation, the frequency error offset can be calculated by measuring the angular difference between the set of {I_{c}, Q_{c}} symbols and

$$\frac{π}{4} .$$

This is because, for

$$\frac{π}{4} DQPSK ,$$

symbols in the first quadrant should be at

$$\frac{π}{4}$$

exactly, symbols in the second quadrant should be at

$$\frac{3 π}{4}$$

exactly, symbols in the third quadrant should be at

$$\frac{- 3 π}{4}$$

exactly and symbols in the fourth quadrant should be at

$$\frac{- π}{4}$$

exactly, and any difference will give an indication of the angular difference. Because the rotation has been performed at block 413, we actually compare with the x-axis. If a symbol lies on the x-axis, the angular difference is zero. This angular difference is converted to a frequency difference and added to the previous frequency offset Δ_{f}′ to obtain an improved value, Δ_{f}′imp. One way to perform the step of obtaining an improved Δ_{f}′ can be performed by blocks 415, 417 and 419. Essentially, we find the average angular difference by summing up all the I and Q signals separately and calculating the angle from the summed I and Q.

Block 415 is an accumulation block and performs the summing up of the I and Q signals:

$$\begin{matrix}sum I = {\sum }_{0}^{K - 1} {I}_{h} & [ 10 ] \\ sum Q = {\sum }_{0}^{K - 1} {Q}_{h} & [ 11 ]\end{matrix}$$

where K is the number of symbols used for the frequency estimation.

Because the symbols are spread around the x-axis, summing up the I and Q actually gives an average I and an average Q. K can be the number of preambles but is usually less than that.

Block 417 is an arctan computation block and computes the angle formed by sum I and sum Q (equations 10 and 11). Since tan of each angle is

$$arctan [ \frac{sum Q}{sum I} ] \qquad [ 12 ]$$

we have for the summed I and the summed Q, an average angle with respect to the x-axis of:

$$arctan [ \frac{sum Q}{sum I} ] \qquad [ 12 ]$$

This average angle corresponds to the secondary frequency offset error Δ_{f}″ that was not used for the correction at block 411.

Block 419 is a frequency offset calculation block and updates the estimated value of the frequency offset by converting the average angle to frequency Δ_{f}″ and adding it to the previously estimated value i.e.
Δ_{f}′ᵢₘₚ=Δ_{f}′+Δ_{f}″ [13]

Δ_{f}″ is smaller than Δ_{f}′ so this update represents a fine tuning of the correction already made at block 411.

FIGS. 4a, 4b and 5 show a prior art arrangement for frequency offset estimation. As already mentioned, frequency offset estimation is very demanding to demodulate QAM signals such as 16 QAM and 64 QAM since these signals are particularly sensitive to phase errors. In fact, the more bits that can be represented per baud, the more sensitive the signal. It has been found that the receiver modem for the Advanced PHS described earlier needs an accuracy of less than about 20 Hz for 64 QAM in order to achieve a sustainable bit error rate of 10⁻⁵. (An accuracy of 20 Hz is rather stringent—it corresponds to around 0.01 ppm frequency error since the transmission frequency of PHS is about 1.9 GHz with a symbol data rate of 192 kHz.) For 16 QAM, the accuracy can be around 50 Hz for the same bit error rate.

Whilst the prior art arrangements, like that described above, do achieve the required accuracy in theory, in practice, the quantization error introduced at the front end can degrade the accuracy. This can sometimes give very poor BER performance.

### SUMMARY OF THE INVENTION

It is an object of the invention to provide a method and apparatus for frequency offset estimation, which mitigate or substantially overcome the problems of prior art arrangements described above.

According to the invention, there is provided estimating apparatus for estimating frequency offset for a receiver for DPSK signals comprising in-phase I and quadrature Q components for a plurality of symbols k, the apparatus comprising:
a differential detector for performing differential detection of a received signal over a symbol span of n symbols, n being an integer greater than 1;
a frequency corrector for performing an initial correction of I and Q using a previously estimated value of the frequency offset;
a rotation block for rotating the phase of each symbol towards zero; and
a calculator for calculating an estimate of the frequency offset by comparing the phase of each symbol with zero, the calculator being arranged to input the estimate into the frequency corrector for improving the previously estimated value of the frequency offset.

The differential detector operates over a symbol span of n symbols, which means that the accuracy of the frequency offset estimation is improved over a one symbol span.

The amount of rotation required in the rotation block will depend on the original phase of each symbol. The rotation block may comprise: a first portion for rotating the phase of each symbol towards the signal constellation of the DPSK modulation and a second portion for rotating the phase of each symbol towards zero. In that case, the rotation towards zero in the rotation block is effectively done in two stages. In the first stage, the symbols are restored to the signal constellation. In the second stage, the symbols are shifted towards zero for comparison with zero in the calculator.

The expression “signal constellation of the DPSK modulation” refers to the angles on which the particular system of modulation is based. For example,

$$\frac{π}{4} DQPSK$$

is based on

$$\frac{π}{4} , \frac{3 π}{4} , \frac{5 π}{4} and \frac{7 π}{4} .$$

The first portion is required when the phase of each symbol has been dislodged from the signal constellation by the differential detection. This will be the case, for example, when n is even and the DPSK signals are based on

$$\frac{π}{4} , \frac{3 π}{4} , \frac{5 π}{4} and \frac{7 π}{4} ,$$

since the symbols are dislodged from

$$\frac{π}{4} , \frac{3 π}{4} , \frac{5 π}{4} and \frac{7 π}{4}$$

and and need to be restored.

The amount of rotation performed in the second portion will depend on the quadrant of the phase once it has been restored to the signal constellation. For a phase in the first quadrant, a rotation of

$$\frac{π}{4}$$

clockwise will be required. For a phase in the second quadrant, a rotation of

$$\frac{3 π}{4}$$

clockwise will be required. For a phase in the third quadrant, a rotation of

$$\frac{5 π}{4}$$

clockwise will be required. For a phase in the fourth quadrant, a rotation of

$$\frac{7 π}{4}$$

clockwise will be required.

The rotation block may use hard decisions for rotating each symbol. Alternatively, the rotation block may use signal preambles for rotating each symbol.

The calculation of the frequency offset estimation in the calculator can be performed in a number of ways. In one embodiment, the calculator comprises: an accumulator for averaging the I and Q for each symbol k over a given number of symbols K; a computation block for calculating the angle formed by the averaged I and Q; and a frequency offset calculation block for calculating the estimate of the frequency offset from the angle formed by the averaged I and Q.

The previously estimated value of the frequency offset may have been estimated using a frequency offset estimation algorithm. In one embodiment, the previously estimated value of the frequency offset is initially set at zero. In another embodiment, the previously estimated value of the frequency offset is initially set at a non-zero value.

In one embodiment, n=4. This is advantageous because performing differential detection over a four symbol span provides a frequency offset estimation which has precision appropriate for 16 QAM and 64 QAM modulated signals. Other arrangements may be envisaged, however, where n=2 or n=3 or n=5 and so on.

In one embodiment, the DPSK modulated signals are

$$\frac{π}{4} DQPSK$$

modulated. Other modulation schemes may be envisaged, however, for example DBPSK,

$$\frac{π}{2} DBPSK$$

and D8PSK.

According to the invention, there is also provided apparatus for estimating frequency offset for a receiver for DPSK signals comprising in-phase I and quadrature Q components for a plurality of symbols k, and for correcting the I and Q components of a received signal using the estimated value of the frequency offset, the apparatus comprising: estimating apparatus as described above; and a second frequency corrector for correcting the I and Q components of the received signal using the estimated value of the frequency offset.

The apparatus may further comprise coarse estimating apparatus for making a coarse estimate of the frequency offset. Since the differential detection performed in the apparatus is performed over a symbol span that is greater than 1 symbol, the precision of the frequency offset estimation is increased, but if the frequency offset is larger than a given amount, the n differential detection may not be able to take account of this. So, providing a coarse estimator in addition can deal with larger offsets.

The coarse estimating apparatus for making a coarse estimate of the frequency offset may perform differential detection over a symbol span of 1. The apparatus for making a coarse estimate of the frequency offset may comprise a second differential detector for performing differential detection of a received signal over one symbol span; a third frequency corrector for performing an initial correction of I and Q using a previously estimated value of the frequency offset; a second rotation block for rotating the phase of each symbol towards zero; and a calculator for calculating the coarse estimate of the frequency offset by comparing the phase of each symbol with zero, the calculator being arranged to input the coarse estimate into the third frequency corrector for improving the previously estimated value of the frequency offset.

The apparatus may further comprise an averaging filter between the estimating apparatus and the second frequency corrector, for smoothing the estimated value of the frequency offset.

According to the invention, there is also provided apparatus for estimating frequency offset for a receiver for DPSK signals comprising in-phase I and quadrature Q components for a plurality of symbols k, and for correcting the I and Q components of a received signal using the estimated value of the frequency offset, the apparatus comprising:
a differential detector for performing differential detection of a received signal over a symbol span of n symbols, n being an integer greater than 1;
a first frequency corrector for performing an initial correction of I and Q using a previously estimated value of the frequency offset;
a rotation block for rotating the phase of each symbol towards zero;
a calculator for calculating an estimate of the frequency offset by comparing the phase of each symbol with zero, the calculator being arranged to input the estimate into the first frequency corrector for improving the previously estimated value of the frequency offset; and
a second frequency corrector for performing correction of I and Q using the estimated value of the frequency offset.

The apparatus may further comprise coarse estimating apparatus for making a coarse estimate of the frequency offset. Since the differential detection performed in the apparatus is performed over a symbol span that is greater than 1 symbol, the precision of the frequency offset estimation is increased, but if the frequency offset is larger than a given amount, the n symbol span differential detection may not be able to take account of this. So, providing a coarse estimator in addition can deal with larger offsets.

The coarse estimating apparatus for making a coarse estimate of the frequency offset may perform differential detection over a symbol span of 1. In one embodiment, the coarse estimating apparatus comprises:
a second differential detector for performing differential detection of a received signal over one symbol span;
a third frequency corrector for performing an initial correction of I and Q using a previously estimated value of the frequency offset;
a second rotation block for rotating the phase of each symbol towards zero; and
a calculator for calculating the coarse estimate of the frequency offset by comparing the phase of each symbol with zero, the calculator being arranged to input the coarse estimate into the third frequency corrector for improving the previously estimated value of the frequency offset.

The apparatus may further comprise an averaging filter between the calculator and the second frequency corrector for smoothing the estimated value of the frequency offset.

According to the invention, there is also provided estimating apparatus for estimating frequency offset for a receiver for

$$\frac{π}{4} DQPSK$$

signals comprising in-phase I and quadrature Q components for a plurality of symbols k, the apparatus comprising:
a differential detector for performing differential detection of a received signal over a symbol span of n symbols, n being an integer greater than 1;
a frequency corrector for performing an initial correction of I and Q using a previously estimated value of the frequency offset;
if n is even, a first rotation block for rotating the phase of each symbol by

$$\frac{π}{4} ;$$
a second rotation block for rotating the phase of each symbol towards zero; and
a calculator for calculating an estimate of the frequency offset by comparing the phase of each symbol with zero, the calculator being arranged to input the estimate into the frequency corrector for improving the previously estimated value of the frequency offset.

According to the invention, there is also provided apparatus for estimating frequency offset for a receiver for

$$\frac{π}{4} DQPSK$$

signals comprising in-phase I and quadrature Q components for a plurality of symbols k, and for correcting the I and Q components of a received signal using the estimated value of the frequency offset, the apparatus comprising:
a differential detector for performing differential detection of a received signal over a symbol span of n symbols, n being an integer greater than 1;
a first frequency corrector for performing an initial correction of I and Q using a previously estimated value of the frequency offset;
if n is even, a first rotation block for rotating the phase of each symbol by

$$\frac{π}{4} ;$$
a second rotation block for rotating the phase of each symbol towards zero;
a calculator for calculating an estimate of the frequency offset by comparing the phase of each symbol with zero, the calculator being arranged to input the estimate into the first frequency corrector for improving the previously estimated value of the frequency offset; and
a second frequency corrector for performing correction of I and Q using the estimated value of the frequency offset.

According to the invention, there is also provided a differential detector for performing differential detection of a received DPSK signal, the signal comprising in-phase I and quadrature Q components for a plurality of symbols k, the differential detector being arranged to perform differential detection over a symbol span of n symbols, n being an integer greater than 1.

In one advantageous embodiment, n=4.

In one embodiment, the DPSK modulated signals are

$$\frac{π}{4} DQPSK$$

modulated. Other modulation schemes may be envisaged, however, for example DBPSK,

$$\frac{π}{2} DBPSK ,$$

D8PSK.

According to the invention, there is also provided a method for estimating frequency offset for received DPSK signals comprising in-phase I and quadrature Q components at a plurality of symbols k, the method comprising the steps of:
a) performing differential detection of a received signal over a symbol span of n symbols, n being an integer greater than 1;
b) performing an initial correction of I and Q using a previously estimated value of the frequency offset;
c) rotating the phase of each symbol towards zero; and
d) calculating an estimate of the frequency offset by comparing the phase of each symbol with zero, the estimate being able to be used at step b) to improve the previously estimated value of the frequency offset.

Step a) of performing differential detection is performed over a symbol span of n symbols, which means that the accuracy of the frequency offset estimation is improved against a single symbol span.

The amount of rotation required at step c) will depend on the original phase of each symbol. Step c) may comprise the steps of: rotating the phase of each symbol towards the signal constellation of the DPSK modulation; and rotating the phase of each symbol towards zero. In that case, step c) is performed in two stages, the symbols being restored to the signal constellation in the first stage and the symbols being shifted towards zero (for comparison in step d)) in the second stage.

The expression “signal constellation of the DPSK modulation” refers to the angles on which the particular system of modulation is based. For example,

$$\frac{π}{4} DQPSK$$

is based on

$$\frac{π}{4} , \frac{3 π}{4} , \frac{5 π}{4} and \frac{7 π}{4} .$$

The first step of step c) is required when the phase of each symbol has been dislodged from the signal constellation by the differential detection step a). This will be the case, for example, when n is even and the DPSK signals are based on

$$\frac{π}{4} , \frac{3 π}{4} , \frac{5 π}{4} and \frac{7 π}{4} ,$$

since the symbols are dislodged from

$$\frac{π}{4} , \frac{3 π}{4} , \frac{5 π}{4} and \frac{7 π}{4}$$

and and need to be restored.

The amount of rotation needed in the second stage of step c) will depend on the quadrant of the phase once it has been restored to the signal constellation in the first stage of step c). For a phase in the first quadrant, a rotation of

$$\frac{π}{4}$$

clockwise will be required. For a phase in the second quadrant, a rotation of

$$\frac{3 π}{4}$$

clockwise will be required. For a phase in the third quadrant, a rotation of

$$\frac{5 π}{4}$$

clockwise will be required. For a phase in the fourth quadrant, a rotation of

$$\frac{7 π}{4}$$

clockwise will be required.

The step of rotating the phase of each symbol towards zero may comprise using hard decisions for rotating the phase of each symbol towards zero. Alternatively, the step of rotating the phase of each symbol towards zero may comprise using signal preambles for rotating the phase of each symbol towards zero.

In one embodiment, step d) of calculating an estimate of the frequency offset comprises: averaging the I and Q for each symbol k over a given number of symbols K; calculating the angle formed by the averaged I and Q; and calculating the estimate of the frequency offset from the angle formed by the averaged I and Q.

The previously estimated value of the frequency offset may have been estimated using a frequency offset estimation algorithm. In one embodiment, the previously estimated value of the frequency offset is initially set at zero. In another embodiment, the previously estimated value of the frequency offset is initially set at a non-zero value.

In one embodiment, n=4. This embodiment is advantageous because performing differential detection over a four symbol span provides a frequency offset estimation which has precision appropriate for 16 QAM and 64 QAM modulated signals.

In one embodiment, the DPSK modulated signals are

$$\frac{π}{4} DQPSK$$

modulated.

Other modulation schemes may be envisaged, however, for example DBPSK,

$$\frac{π}{2} DB \dot{P} SK$$

and D8PSK.

According to the invention, there is also provided a method for estimating frequency offset for received DPSK signals comprising in-phase I and quadrature Q components for a plurality of symbols k, and for correcting the I and Q components of a received signal using the estimated value of the frequency offset, the method comprising: a method as described above; and the step of correcting the I and Q components of the received signal using the estimated value of the frequency offset.

The method may further include the step of making a coarse estimate of the frequency offset. Since step a) of performing differential detection is performed over a symbol span that is greater than 1 symbol, the precision of the frequency offset estimation is increased, but if the frequency offset is larger than a given amount, the n differential detection may not be able to take account of this. So, providing a further step of making a coarse estimate of the frequency offset can deal with larger offsets.

The step of making a coarse estimate of the frequency offset may comprise the steps of:
i) performing differential detection of a received signal over a symbol span of one symbol;
ii) performing an initial correction of I and Q using a previously estimated value of the frequency offset;
iii) rotating the phase of each symbol towards zero; and
iv) calculating the coarse estimate of the frequency offset by comparing the phase of each symbol with zero, the estimate being able to be used at step ii) to improve the previously estimated value of the frequency offset.

The method may further comprise, before the step of correcting the I and Q components of the received signal, smoothing the estimated value of the frequency offset.

According to the invention, there is also provided a method for estimating frequency offset for received

$$\frac{π}{4} DQPSK$$

signals comprising in-phase I and quadrature Q components at a plurality of symbols k, the method comprising the steps of:
a) performing differential detection of a received signal over a symbol span of n symbols, n being an integer greater than 1;
b) performing an initial correction of I and Q using a previously estimated value of the frequency offset;
c) if n is even, rotating the phase of each symbol by

$$\frac{π}{4} ;$$
d) rotating the phase of each symbol towards zero; and
e) calculating an estimate of the frequency offset by comparing the phase of each symbol with zero, the estimate being able to be used at step b) to improve the previously estimated value of the frequency offset.

Features described in relation to one aspect of the invention may also be applicable to another aspect of the invention.

### BRIEF DESCRIPTION OF THE DRAWINGS

Some known arrangements have already been described with reference to FIG. 1 to 5 of the accompanying drawings, of which:

FIG. 1 is a signal space diagram for 16 QAM;

FIG. 2 is a signal space diagram for 64 QAM;

FIG. 3 shows the slot structure for a prior art arrangement;

FIG. 4a is a block diagram of a prior art transmission side for

$$\frac{π}{4} DQPSK ;$$

FIG. 4b is a block diagram of a prior art receiver side for

$$\frac{π}{4} DQPSK ;$$

and

FIG. 5 is a schematic diagram showing decision based rotation according to the prior art.

Some exemplary embodiments of the invention will now be described with reference to FIGS. 6 to 10 of the accompanying drawings, of which

FIG. 6 is a block diagram of the receiver side according to a first embodiment of the invention;

FIG. 7 is detailed block diagram of block 601 of FIG. 6;

FIG. 8 is a schematic diagram showing

$$\frac{π}{4}$$

rotation as performed by block 705 of FIG. 7;

FIG. 9 is a block diagram of a receiver side according to a second embodiment of the invention; and

FIG. 10 is a block diagram of a receiver side according to a third embodiment of the invention.

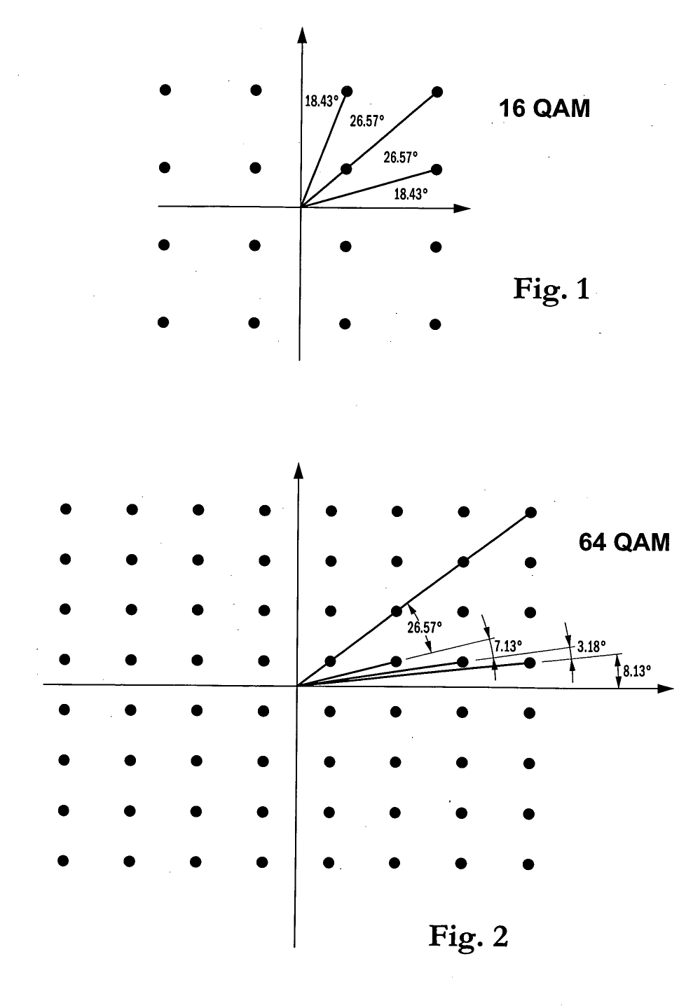

### DETAILED DESCRIPTION OF PREFERRED EMBODIMENTS

In the first embodiment, fine frequency offset estimation 601 is followed by correction of the frequency offset 603. This is shown in FIG. 6.

The fine frequency offset estimation 601 consists of several different stages and these are shown schematically in FIG. 7. The fine frequency estimation shown in FIG. 7 comprises a differential detector block (for four symbol span) 701, a frequency correction block 703, a

$$\frac{π}{4}$$

rotation block 705, a decision-based rotation block 707, an accumulation block 709, an arctan computation block 711 and a frequency offset calculation block 713.

Just as with FIG. 4b, the received signal is represented by Iᵣ and Qᵣ and we assume that Iᵣ and Qᵣ are digitized and contain frequency offset, since they have passed through coherent PSK modulation.

Block 701 performs differential detection of four symbol span i.e.
I_{d}(k)=Iᵣ(k)Iᵣ(k−4)+Qᵣ(k)Qᵣ(k−4) [14]
Q_{d}(k)=Qᵣ(k)Iᵣ(k−4)−Iᵣ(k)Qᵣ(k−4) [15]

Comparing this with the prior art arrangement (equations [6] and [7]), we see that the difference is that we are now performing differential detection over four symbols rather than one symbol. This has an effect on the precision of the resulting estimation of the frequency offset and this will be discussed further below.

Block 703 performs a frequency correction using a previously estimated value of the frequency offset Δ_{f}′ to compensate for the differential detection output, just like prior art block 411. Therefore, just as before:
I_{c}(k)=I_{d}(k)cos(2πΔ_{f}′k)+Q_{d}(k)sin(2πΔ_{f}′k) [8]
Q_{c}(k)=Q_{d}(k)cos(2πΔ_{f}′k)−I_{d}(k)sin(2πΔ_{f}′k) [9]

Block 705 is a

$$\frac{π}{4}$$

rotation block and performs a

$$\frac{π}{4}$$

rotation on the symbol. This is required because the symbol was dislodged by the four-symbol differential detection so now forms the base of

$$\{ 0 , \frac{π}{2} , π , \frac{3 π}{2} \} .$$

After the

$$\frac{π}{4}$$

rotation, it returns to the middle of the quadrants i.e.

$$\{ \frac{π}{4} , \frac{3 π}{4} , \frac{5 π}{4} , \frac{7 π}{4} \} ,$$

the values on which the

$$\frac{π}{4} DQPSK$$

system of modulation is based. The

$$\frac{π}{4}$$

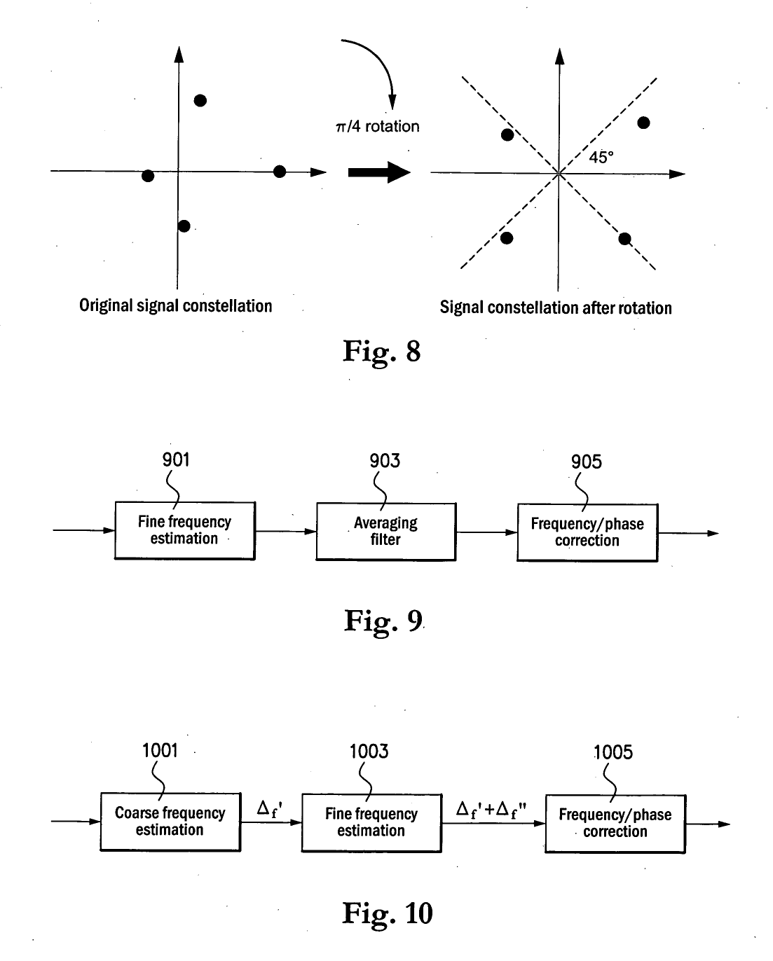

rotation of block 705 is shown in FIG. 8.

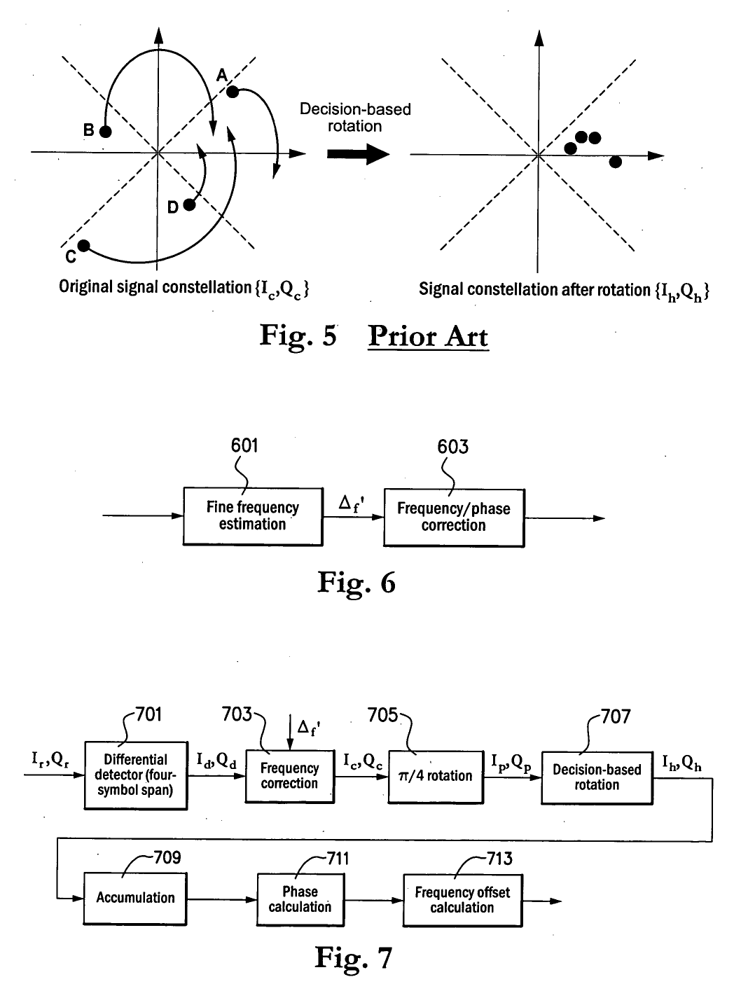

Block 707 performs decision based rotation to produce Iₙ and Qₙ just like block 413 of the prior art. So the I and Q values are rotated towards the x-axis of the first quadrant as shown in FIG. 5, which simplifies the next comparison step.

It is foreseeable that blocks 705 and 707 could be combined to produce a single rotation of an amount which is appropriate depending on the quadrant in which the symbol is located.

Just as in the prior art, once the decision-based rotation has been performed, the frequency error offset can be calculated by measuring the phase difference Δₚ″ between the set of {Iₙ, Qₙ} symbols and

$$\frac{π}{4} .$$

Because the rotation has been performed at block 707, we compare with the x-axis. The frequency corresponding to the phase difference is added to the previous frequency offset Δ_{f}′ to obtain an improved value, Δ_{f}′imp.

In this embodiment, this is performed by accumulation block 709, arctan computation block 711 and frequency offset calculation block 713. Accumulation block 709 is the same as prior art block 415:

$$\begin{matrix}sum I = {\sum }_{0}^{K - 1} {I}_{h} & [ 10 ] \\ sum Q = {\sum }_{0}^{K - 1} {Q}_{h} & [ 11 ]\end{matrix}$$

where K is the number of symbols used for the frequency estimation. Once again, because of the scattering of the symbols around the x-axis, this provides averaged I and Q.

Arctan computation block 711 is the same as prior art block 417 and provides average angle:

$$arctan [ \frac{sum Q}{. sum I} ] \qquad [ 12 ]$$

This average angle corresponds to the frequency offset error which provides fine tuning of the correction made in block 703. Block 713 updates the frequency error offset by adding the frequency difference derived from the computed average angle i.e.

$${Δ}_{f imp}^{′} = {Δ}_{f}^{′} + \frac{{Δ}_{f}^{″}}{4} \qquad [ 16 ]$$

Note that equation [16] differs from prior art equation [13] by adding

$$\frac{{Δ}_{f}^{″}}{4}$$

rather than Δ_{f}″. This is because of the four symbol (rather than one symbol) differential detection and will be explained in more detail below.

Referring once again to FIG. 6, the frequency and phase correction block 603 uses the output Δ_{f}′imp from the fine frequency estimation block 601 (as shown in FIG. 7 and described above) and the estimated phase offset Δₚ′ (not discussed here) to correct frequency and phase offset error:
I_{corrected}(k)=I(k)cos(2πΔ_{f}′k+Δₚ′)+Q(k)sin(2πΔ_{f}′k+Δₚ′) [17]
Q_{corrected}(k)=Q(k)cos(2πΔ_{f}′k+Δₚ′)−I(k)sin(2πΔ_{f}′k+Δₚ′) [18]

Note that, when we compare the arrangement of FIG. 7 with the prior art arrangement shown in FIG. 4b, we see that there are essentially three differences. Firstly, the differential detection takes place over four symbols rather than one. Secondly, a

$$\frac{π}{4}$$

rotation is included to compensate for the four symbol differential detection. Thirdly, the frequency offset calculation block updates the frequency error offset by adding 1/4 of Δ_{f}″ Again, this is to account for the four symbol differential detection.

The quantization error in fixed-point design adds an estimation error to the estimated phase of the differential detector output. The error is tolerable for differential encoding modulation but may cause error floor for non-differential encoding modulation such as 16 QAM or 64 QAM especially for longer bursts. This error is independent of the number of symbols that the differential detector spans.

As mentioned above, the number of symbols over which the differential detection is performed has an effect on the precision of the frequency estimation. In fact, as the symbol span increases, the frequency estimation becomes more precise. For differential detection over one symbol span (as in the prior art), frequency offset errors of up to a quadrant

$$( \frac{π}{2} )$$

can be detected and corrected. For differential detection over four symbol span (as in the described embodiment), frequency offset errors of only a quarter of a quadrant

$$( \frac{π}{8} )$$

can be detected and corrected. This improves precision, but does mean that larger errors (greater than a quarter of a quadrant) may not be accounted for. The process is essentially a fine frequency offset estimation.

This increase in precision comes about because, while the number of multiple frequency offset error increases, the quantization error component and other noise components remain the same. Considering the effects of quantization error and noise n_{q} using one-symbol differential detection, the frequency offset plus quantization error and noise is: Δ_{f}″+n_{q}. However, using four-symbol differential detection, the frequency offset plus quantization error and noise is: 4Δ_{f}″+n_{q}, or, after dividing by four, is:

$${Δ}_{f}^{″} + \frac{{n}_{q}}{4} .$$

Therefore, the quantization error component and other noise components are reduced to ¼ of their previous value and the residual frequency offset error could be within 20 Hz as required by, for example, 64 QAM.

FIG. 9 is block diagram of the receiver side according to a second embodiment of the invention. Just like the first embodiment, fine frequency offset estimation 901 is followed by correction of the frequency offset 905. However, additionally averaging IIR (Infinite Impulse Response) is provided by averaging filter 903 to smooth Δ_{f}′ over many samples.

A possible averaging filter is the classical IIR filter:
Δ_{f}′_{long}_{_{—}}ₜᵢₘₑ_{_{—}}ₐᵥₑ=Δ_{f}′_{long}_{_{—}}ₜᵢₘₑ_{_{—}}ₐᵥₑ×(1−η)+η×Δ_{f}′_{new}_{_{—}}ₑₛₜᵢₘₐₜᵢₒₙ [19]
where η is the smoothing factor.

FIG. 10 is a block diagram of the receiver side according to a third embodiment of the invention. Just like the first and second embodiments, fine frequency offset estimation 1003 is followed by correction of the frequency offset 1005. However, prior to the fine frequency offset estimation 1003, coarse frequency offset estimation 1001 is provided.

As already mentioned, the four symbol differential detection is essentially a fine frequency offset error estimation process since the error that can be detected and corrected is limited. So, the coarse frequency offset error estimation 1001 can be performed first to pick up and correct larger errors than the four symbol differential detection can deal with. The four symbol differential detection is used to fine tune the first estimation.

The coarse frequency estimation 1001 may be one symbol span differential detection just like the prior art or it may be data-aided using preamble correction, or any other known coarse frequency estimation.

Three embodiments have been illustrated and described but it will be appreciated by the skilled person that various other changes may be made, still within the scope of the present invention. For example, the differential detection span may be any number, not necessarily four. As the symbol span number increases, the frequency offset error range which can be estimated becomes smaller (i.e. reduced to 1/n of a quadrant

$$( \frac{π}{2 n} )$$

where n is the symbol span number). Also, depending on whether the symbol span number is odd or even, the rotation of

$$\frac{π}{4}$$

may or may not be necessary.

Also, the algorithm could be modified to be applicable to other differential decoded signals e.g. DQPSK,

$$\frac{π}{2} DQPSK .$$

Referring to FIG. 7, blocks 701, 703, 709, 711 and 713 would not be changed for another type of modulation Block 705 would apply an appropriate rotation (not necessarily

$$\frac{π}{4} )$$

which would depend on the type of modulation and could be zero. Block 707 would still move the symbols towards the x-axis but the amount of rotation required would be dependent on the base phases of the modulation scheme used. The frequency estimation can be used as a reference for other modulated signals in the slot, for example the

$$\frac{π}{4} DQPSK$$

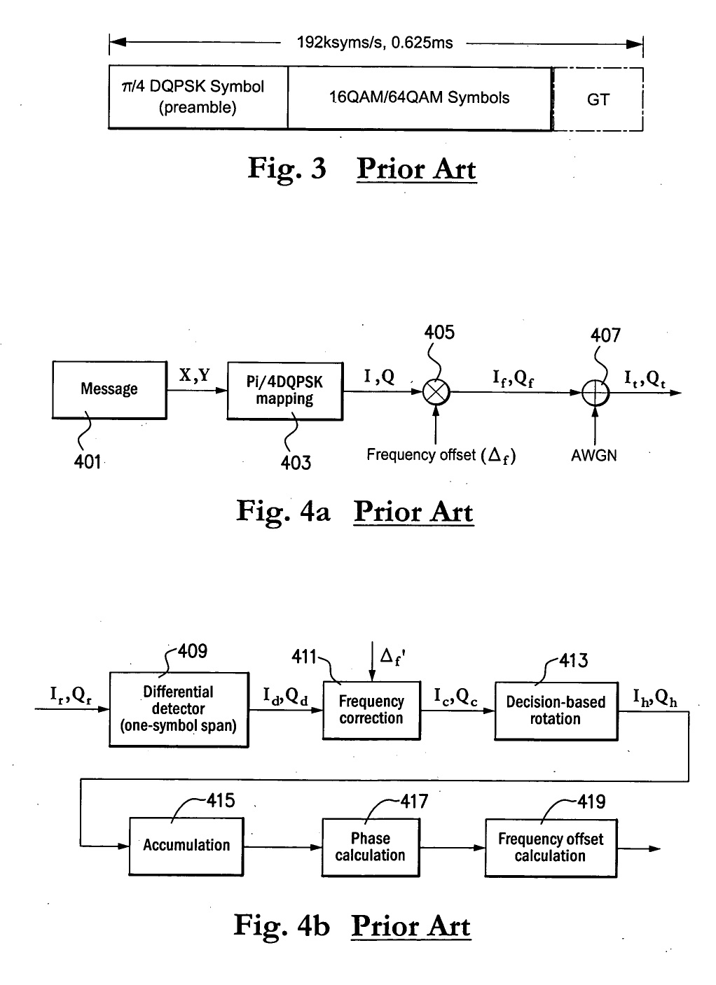

frequency estimation could be used to correct frequency offset in 16 QAM or 64 QAM in the slot structure illustrated in FIG. 3.

1. Estimating apparatus for estimating frequency offset for a receiver for DPSK signals comprising in-phase I and quadrature Q components for a plurality of symbols k, the apparatus comprising:
a differential detector for performing differential detection of a received signal over a symbol span of n symbols, n being an integer greater than 1;
a frequency corrector for performing an initial correction of I and Q using a previously estimated value of the frequency offset;
a rotation block for rotating the phase of each symbol towards zero; and
a calculator for calculating an estimate of the frequency offset by comparing the phase of each symbol with zero, the calculator being arranged to input the estimate into the frequency corrector for improving the previously estimated value of the frequency offset.

2. Estimating apparatus according to claim 1 wherein the rotation block comprises:
a first portion for rotating the phase of each symbol towards the signal constellation of the DPSK modulation; and
a second portion for rotating the phase of each symbol towards zero.

3. Estimating apparatus according to claim 1 wherein the calculator comprises:
an accumulator for averaging the I and Q for each symbol k over a given number of symbols K;
a computation block for calculating the angle formed by the averaged I and Q; and
a frequency offset calculation block for calculating the estimate of the frequency offset from the angle formed by the averaged I and Q.

4. Estimating apparatus according to claim 1 wherein the previously estimated value of the frequency offset was estimated using a frequency offset estimation algorithm.

5. Estimating apparatus according to claim 1 wherein n=4.

6. Apparatus for estimating frequency offset for a receiver for DPSK signals comprising in-phase I and quadrature Q components for a plurality of symbols k, and for correcting the I and Q components of a received signal using the estimated value of the frequency offset, the apparatus comprising:
a differential detector for performing differential detection of a received signal over a symbol span of n symbols, n being an integer greater than 1;
a first frequency corrector for performing an initial correction of I and Q using a previously estimated value of the frequency offset;
a rotation block for rotating the phase of each symbol towards zero;
a calculator for calculating an estimate of the frequency offset by comparing the phase of each symbol with zero, the calculator being arranged to input the estimate into the first frequency corrector for improving the previously estimated value of the frequency offset; and
a second frequency corrector for performing correction of I and Q using the estimated value of the frequency offset.

7. Apparatus according to claim 6 further comprising coarse estimating apparatus for making a coarse estimate of the frequency offset.

8. Apparatus according to claim 7 wherein the coarse estimating apparatus comprises:
a second differential detector for performing differential detection of a received signal over one symbol span;
a third frequency corrector for performing an initial correction of I and Q using a previously estimated value of the frequency offset;
a second rotation block for rotating the phase of each symbol towards zero; and
a calculator for calculating the coarse estimate of the frequency offset by comparing the phase of each symbol with zero, the calculator being arranged to input the coarse estimate into the third frequency corrector for improving the previously estimated value of the frequency offset.

9. Apparatus according to claim 6 further comprising an averaging filter between the calculator and the second frequency corrector for smoothing the estimated value of the frequency offset.

10. Estimating apparatus for estimating frequency offset for a receiver for
$$\frac{π}{4} DQPSK$$
signals comprising in-phase I and quadrature Q components for a plurality of symbols k, the apparatus comprising:
a differential detector for performing differential detection of a received signal over a symbol span of n symbols, n being an integer greater than 1;
a frequency corrector for performing an initial correction of I and Q using a previously estimated value of the frequency offset;
if n is even, a first rotation block for rotating the phase of each symbol by
$$\frac{π}{4} ;$$
a second rotation block for rotating the phase of each symbol towards zero; and
a calculator for calculating an estimate of the frequency offset by comparing the phase of each symbol with zero, the calculator being arranged to input the estimate into the frequency corrector for improving the previously estimated value of the frequency offset.

11. Apparatus according to claim 10, for correcting the I and Q components of a received signal using the estimated value of the frequency offset, the apparatus further comprising:
a second frequency corrector for performing correction of I and Q using the estimated value of the frequency offset.

12. A method for estimating frequency offset for received DPSK signals comprising in-phase I and quadrature Q components at a plurality of symbols k, the method comprising the steps of:
a) performing differential detection of a received signal over a symbol span of n symbols, n being an integer greater than 1;
b) performing an initial correction of I and Q using a previously estimated value of the frequency offset;
c) rotating the phase of each symbol towards zero; and
d) calculating an estimate of the frequency offset by comparing the phase of each symbol with zero, the estimate being able to be used at step b) to improve the previously estimated value of the frequency offset.

13. A method according to claim 12 wherein step c) of rotating the phase of each symbol towards zero comprises:
rotating the phase of each symbol towards the signal constellation of the DPSK modulation; and
rotating the phase of each symbol towards zero.

14. A method according to claim 12 wherein step d) of calculating an estimate of the frequency offset comprises:
averaging the I and Q for each symbol k over a given number of symbols K;
calculating the angle formed by the averaged I and Q; and
calculating the estimate of the frequency offset from the angle formed by the averaged I and Q.

15. A method according to claim 12 wherein n=4.

16. A method according to claim 12 wherein the signals are
$$\frac{π}{4} DQPSK$$
modulated signals.

17. A method according to claim 12, for correcting the I and Q components of a received signal using the estimated value of the frequency offset, the method further comprising:
correcting the I and Q components of the received signal using the estimated value of the frequency offset.

18. A method according to claim 17 further including the step of making a coarse estimate of the frequency offset.

19. A method according to claim 18 wherein the step of making a coarse estimate of the frequency offset comprises the steps of:
i) performing differential detection of a received signal over a symbol span of one symbol;
ii) performing an initial correction of I and Q using a previously estimated value of the frequency offset; and
iii) rotating the phase of each symbol towards zero; and
iv) calculating the coarse estimate of the frequency offset by comparing the phase of each symbol with zero, the estimate being able to be used at step ii) to improve the previously estimated value of the frequency offset.

20. A method according to claim 17 further comprising the step of, before the step of correcting the I and Q components of the received signal, smoothing the estimated value of the frequency offset.
